(19) United States
(12) Patent Application Publication
(10) Pub. No.: US 2015/0189010 A1
(43) Pub. Date: Jul. 2, 2015

(54) COMMUNICATION NETWORK WITH LOAD BALANCING FUNCTIONALITY

(71) Applicant: Alcatel-Lucent Canada Inc., Ottawa (CA)

(72) Inventor: Jeroen van Bemmel, Calgary (CA)

(21) Appl. No.: 14/143,526

(22) Filed: Dec. 30, 2013

(51) Int. Cl. H04L 29/08; H04L 29/06

(52) U.S. Cl. CPC H04L 67/1014; H04L 67/42; H04L 69/16

(57) ABSTRACT

A load balancer selects a processing device from a set of processing devices in a communication network to serve a request received by the load balancer from a client device. The load balancer forwards the request to the selected processing device such that the selected processing device can provide at least one response to the client device without the response passing through the load balancer. The response comprises a value inserted therein that is unique to the selected processing device. An acknowledgement is received at the load balancer from the client device, wherein the acknowledgement comprises the unique value associated with the selected processing device. The acknowledgement with the unique value is forwarded from the load balancer to the selected processing device such that the selected processing device can delete state information associated with the request. Selection of the processing device may be based on content of the request.

### FIELD

The application relates generally to communication networks, and more particularly to communication protocols implementing load balancing functionality.

### BACKGROUND

Load balancing solutions in communication networks have been around for decades. For example, consider a content delivery network or content distribution network (CDN) wherein a large number of servers are deployed in distributed data centers across the Internet. A CDN serves content to end-users (i.e., “client device,” “user device,” “user,” “client”). Content may include, but is not limited to, web objects (e.g., text, graphics, and scripts), downloadable objects (e.g., media files, software, documents), applications (e.g., e-commerce, portals), streaming media, and social network content.

In CDN solutions, load balancing of requests for content is achieved through Hypertext Transfer Protocol (HTTP) redirection. HTTP is described in the Internet Engineering Task Force (IETF) Request for Comments (RFC) 2616, “Hypertext Transfer Protocol—HTTP/1.1,” June 1999; and IETF RFC 2617, “HTTP Authentication: Basic and Digest Access Authentication,” June 1999, which are incorporated by reference herein. A HTTP GET request for content is first sent from a client to a “service node,” which selects a delivery appliance for handling the request based on location (relative proximity to the client), load, and content being requested. The service node then sends a 302 HTTP redirect response, which causes the client to initiate a second HTTP connection (with the selected delivery appliance).

Drawbacks of the above approach include the overhead of setting up two connections for each content request, and the additional latency introduced, both of which can represent large overhead especially in cases of relatively small content (such as application programming interface (API) requests).

Moreover, this approach does not protect against attacks such as SYN flooding; both the distribution server and the content delivery servers are directly exposed to the Internet, and can be individually targeted. SYN flooding is a form of a denial-of-service attack wherein an attacker sends a succession of SYN requests to a system in an attempt to overload the system's ability to respond to legitimate requests. A SYN request is part of handshake procedure in the Transmission Control Protocol (TCP). TCP is described in the IETF RFC 793, “Transmission Control Protocol, DARPA Internet Program, Protocol Specification,” September 1981, which is incorporated by reference herein.

A second known load balancing method is called “Distributed TCP” as described in an article by R. Kokku et al., “Distributed TCP: An Efficient Infrastructure to Support Persistent Connections,” IBM Research, 2000. Although this approach avoids the overhead of a second connection setup, it is stateful and adds overhead in case multiple backend servers are involved sequentially. Also, this distributed TCP approach is not transparent to applications.

A conventional technique for processing TCP statelessly involves the use of so-called SYN cookies, see, IETF RFC 4987, “TCP SYN Flooding Attacks and Common Mitigations,” August 2007, which is incorporated by reference herein. Based on this SYN cookie approach, encoding of state in the TCP initial sequence number and/or timestamp value is known.

### SUMMARY

Illustrative embodiments of the invention provide improved load balancing techniques for use in a communication network. While embodiments are applicable to varied types of communication networks, one or more embodiments are particularly well-suited for use in a TCP-based network environment.

In one embodiment, a method includes the following steps. A load balancer selects a processing device from a set of processing devices in a communication network to serve a request received by the load balancer from a client device. The load balancer forwards the request to the selected processing device such that the selected processing device can provide at least one response to the client device without the response passing through the load balancer. The response comprises a value inserted therein that is unique to the selected processing device. An acknowledgement is received at the load balancer from the client device, wherein the acknowledgement comprises the unique value associated with the selected processing device. The acknowledgement with the unique value is forwarded from the load balancer to the selected processing device such that the selected processing device can delete state information associated with the request. Selection of the processing device may be based on content of the request.

Advantageously, illustrative embodiments provide content-based, stateless load balancing functionality that overcomes the above and other drawbacks associated with TCP-based communications protocols and the like.

These and other features and advantages of the present invention will become more apparent from the accompanying drawings and the following detailed description.

### BRIEF DESCRIPTION OF THE DRAWINGS

FIG. 1 shows a communication network environment in which one or more embodiments of the invention are implemented.

FIG. 2 shows a content-based, stateless load balancing methodology according to an embodiment of the invention.

FIG. 3 shows a processing platform on which networks and methodologies according to one or more embodiments of the invention can be implemented.

### DETAILED DESCRIPTION

Illustrative embodiments of the invention will be described herein with reference to exemplary communication networks, user devices, network nodes; and associated communication protocols. It should be understood, however, that embodiments of the invention are not limited to use with the particular arrangements described, but are instead more generally applicable to any communication network application in which it is desirable to provide improved performance by providing content-based, stateless load balancing functionality.

As illustratively used herein, the term “stateless” indicates that a processing device or software program is designed to not maintain one or more preceding events in a given sequence of interactions with a user, another processing device or software program. That is, each interaction request is handled based on information that comes with the request, thus there is no state stored (wherein “state” is a set of conditions at a particular time instance).

Further, it is to be understood that the terms “request,” “response,” “reply,” “acknowledgement,” and the like, are examples of messages that are transmitted via one or more communication protocols. Depending on the context, as will be understood by one of ordinary skill in the art given the teachings herein, such terms can be interchanged and thus the message name/type is not necessarily intended to limit the function of the message.

As mentioned above, while embodiments are applicable to varied types of communication networks, one or more embodiments are particularly well-suited for use in a TCP-based network environment. Accordingly, before describing content-based, stateless load balancing embodiments, an explanation of how a TCP connection is established will be given, as well as the conventional concept of SYN cookies used to mitigate SYN flooding attacks.

Before a client attempts to connect with a server in accordance with TCP, the server must first bind to and listen at a port in order to open the port up for connections. This is typically called a “passive open.” Once the passive open is established, a client may initiate an “active open” to establish a connection. This is accomplished in TCP via a three-way handshake procedure as follows:
1. SYN: The active open is performed by the client sending a SYN message to the server. The client sets the sequence number of the segment to a random value X.
2. SYN-ACK: In response, the server replies with a SYN-ACK message. The acknowledgment number is set to one more than the received sequence number, i.e., X+1, and the sequence number that the server chooses for the packet is another random value Y.
3. ACK: The client sends an ACK message back to the server. The sequence number is set to the received acknowledgement value, i.e., X+1, and the acknowledgement number is set to one more than the received sequence number, i.e., Y+1.

Both the client and server, at this point, have received an acknowledgment of the connection. Accordingly, it is to be understood that steps 1 and 2 above serve to establish the connection parameter (sequence number) for one direction of the connection, and this parameter is acknowledged. Steps 2 and 3 serve to establish the connection parameter (sequence number) for the other direction of the connection, and this parameter is acknowledged. Following this three-way handshake procedure, a full-duplex connection is established between the client and the server.

In the SYN flooding attack, a malicious client sends a SYN to a server, and simply does not send the expected ACK back to the server. Alternatively, the malicious client can falsify the source Internet Protocol (IP) address in the SYN message, causing the server to send the SYN-ACK to the falsified IP address which will not send an ACK since it did not send the original SYN. In an attack, an increasingly large number of these half opened connections bind resources on the server until no new connections can be made, resulting in a denial of service to legitimate traffic.

The concept of SYN cookies has been proposed to avoid a SYN flooding attack. SYN cookies are defined as particular choices of initial TCP sequence numbers by TCP servers. More specifically, the use of SYN cookies allows a server to avoid dropping connections when its SYN queue fills up, presumably during a SYN flooding attack. Instead, the server effectively operates as if the SYN queue has been expanded. The server sends back the appropriate SYN-ACK response to the client but discards the SYN queue entry. If the server then receives a subsequent ACK response from the client, the server is able to reconstruct the SYN queue entry using information encoded in the TCP sequence number.

We now turn to a detailed description of embodiments of the invention that implement improved load balancing in a TCP-based network that avoids the HTTP redirection issue while also addressing the issue of SYN flooding.

Illustrative embodiments implement a stateless TCP load balancer frontend approach which answers the initial 3-way handshake (SYN, SYN-ACK, ACK) in a stateless way. Upon receiving a data segment (e.g., HTTP GET, SIP REGISTER, WebSocket connection with cookie, etc.), the load balancer selects a target server and forwards the request. The target server is patched to accept such “handed-off” connections and forwards its response packets directly to the client, inserting a specific timestamp header which the client echoes in its ACKs. After finishing its response, the target server inserts a special value signaling to the load balancer to select a next (possibly different) server upon the next data segment, and closes its connection (without signaling the closure to the client).

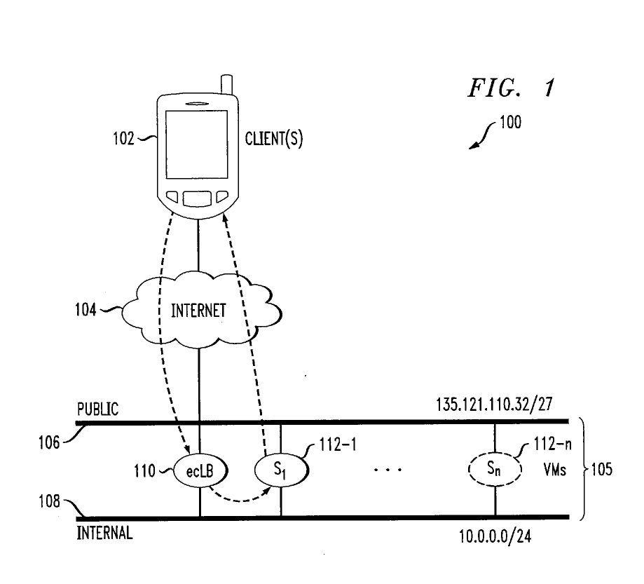

FIG. 1 illustrates a single-level TCP load balancing solution according to one embodiment of the invention. In this network environment, one or more clients (e.g., client 102) communicate with a data center 105 over a network (Internet) 104. It is assumed that the communication protocol includes TCP. The data center 105 is comprised of, inter alia, a frontend load balancer ecLB (110) and a plurality of backend servers S₁ through Sₙ (112-1 through 112-n). In this embodiment, the acronym “ecLB” refers to an elastic cloud load balancer. Load balancer ecLB 110 is implemented in this embodiment as a virtual machine (VM), although embodiments of the invention are not so limited. ecLB receives TCP packets from client(s) 102 on its public network interface 106, and communicates with backend servers 112-1 through 112-n on its internal network interface 108.

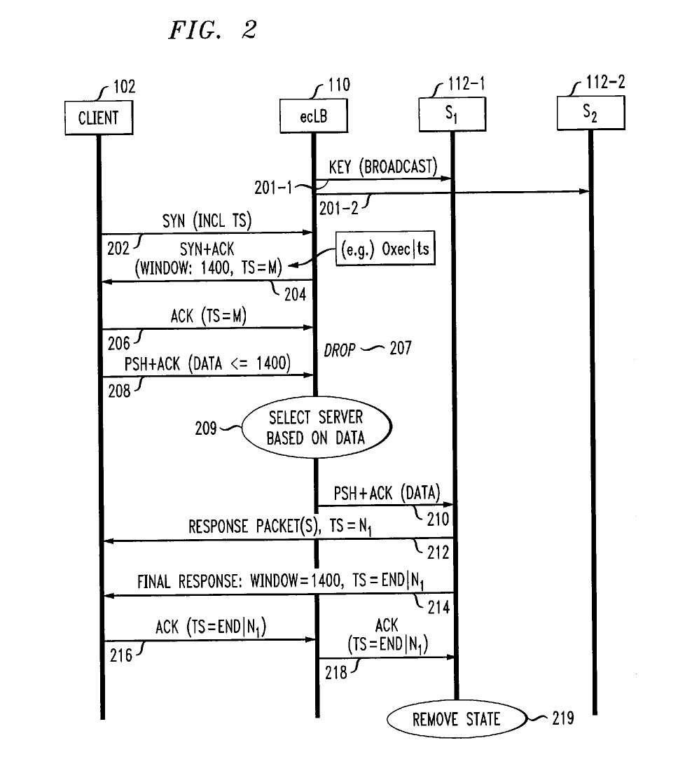

At startup and periodically, the load balancer 110 broadcasts a probe packet (which includes a key) onto the internal network 108, and all active servers (112-1 through 112-n) store the key and respond with their current load. In this way, the load balancer 110 discovers the set of available servers. The servers use the key for verifying incoming connections that have been accepted by the load balancer (on behalf of the backend servers). The dashed arrow lines in FIG. 1 between client, ecLB, and S₁ ( . . . Sₙ) represent illustrative communication flow that will be further explained below in the context of FIG. 2.

FIG. 2 shows a content-based, stateless load balancing methodology according to an embodiment of the invention. Reference will be made to the same components shown in FIG. 1, with the assumption (only for the sake of simplicity of explanation) that there are two backend servers 112-1 and 112-2 (i.e., n=2).

In steps 201-1 and 201-2, the load balancer ecLB 110 broadcasts a verification key to backend servers 112-1 and 112-2, respectively, as explained above.

In step 202, client 102 sends a SYN request to initiate a connection with the data center 105. The SYN request includes a timestamp option TS.

Upon receiving the SYN request containing the timestamp option TS, the load balancer 110 statelessly responds, in step 204, with a SYN-ACK response on behalf of the backend servers. The load balancer 110 inserts a specific value M as the timestamp which, in one embodiment, consists of a 24-bit representation of the current time (in milliseconds or ms) and a prefix value (e.g., 0xec). The load balancer 110 also inserts a limited window size (e.g., window: 1400 bytes), specifying that the client can send at most one frame worth of data.

In step 206, client 102 returns an ACK message to load balancer 110 with the timestamp set to M. However, in accordance with this illustrative embodiment, any subsequent ACK with TS=M but without data is silently discarded by the load balancer 110. By silently discarded, it is meant that the load balancer does not inform the client that its ACK was discarded. It is assumed that the ACK in step 206 is one of these types of ACK messages, and thus this ACK is dropped in step 207. It is to be appreciated that the load balancer 110 discards subsequent TCP ACK frames with the prefix/timestamp but without data (typically, one) in order to delay selecting a backend server until content is available.

In step 208, it is assumed that client 102 returns an ACK message to load balancer 110 with a data segment that matches the prefix (note that the PSH (push) flag in the TCP header informs the receiving host that the data should be pushed up to the receiving application immediately). The load balancer 110 checks the 24-bit timestamp in the ACK against the current time (allowing for wrap-around). If the timestamp was sent recently (e.g., less than 2000 milliseconds ago, which is selectable), the data is forwarded to a backend server, which is selected in step 209 based on the content of the data (amongst other factors, e.g., server load, server distance to client, server location, etc.). This content can be, for example, a HTTP URI (Uniform Resource Identifier), a SIP (Session Initiation Protocol) message with a From/To header, a WebSocket setup request with a session cookie denoting a specific backend server, etc. The load balancer 110 applies a cryptographic hash to parts of the forwarded packet, using the verification key it distributed to the backend servers.

The selected backend server (in this example, assumed to be server 112-1(S₁)) receives the data segment (PSH+ACK (data)) in step 210 and validates that it is authentic (using the key the server stored previously, after the broadcast step 201-1, per listening socket when handling a WebSocket request). When verified, the backend server 112-1 constructs its connection state and responds to the client directly (not through load balancer 110) with the response packet(s) in step 212. Note that the backend server 112-1 inserts a timestamp value N₁ in its response(s) sent in step 212. Timestamp value N₁ is a value that uniquely identifies this particular server. Each backend server has a unique timestamp value N assigned (e.g., backend server 112-2 has N₂, etc.). In step 214, the backend server 112-1 sends its last response directly (not through load balancer 110) to the client which includes also includes an ‘end’ value. This value is a bit in the N₁ timestamp field (e.g., bit31) denoting “end of content” (from the given backend server) to the client. The response in step 214 also specifies the window size limit.

In step 216, client 102 responds to load balancer 110 with an ACK message including N1 with the ‘end’ bit. Load balancer 110 uses N₁ to forward ACK packets to the correct backend server in a stateless way, e.g., to backend server 112-1 in step 218. In step 219, backend server 112-1 deletes any state associated with this particular request (originally initiated in step 202).

Note that when load balancer 110 next receives a data segment from client 102, the load balancer again selects a backend server (possibly different than the previous one), and forwards the new request to this selected server. In case the server is different, a copy of the request packet without the data is sent to the first server to acknowledge receipt (to stop retransmissions). The first server removes its state for the connection, without signaling the client.

Note that while illustrative embodiments of the invention modify conventional operations associated with backend servers, existing TCP clients and server applications (e.g., standard web servers such as nginx) do not have to be modified. It is also to be appreciated that illustrative embodiments of the invention can be implemented with other connection oriented protocols such as, but not limited to, IETF RFC 4960, “Stream Control Transmission Protocol,” September 2007, which is incorporated by reference herein.

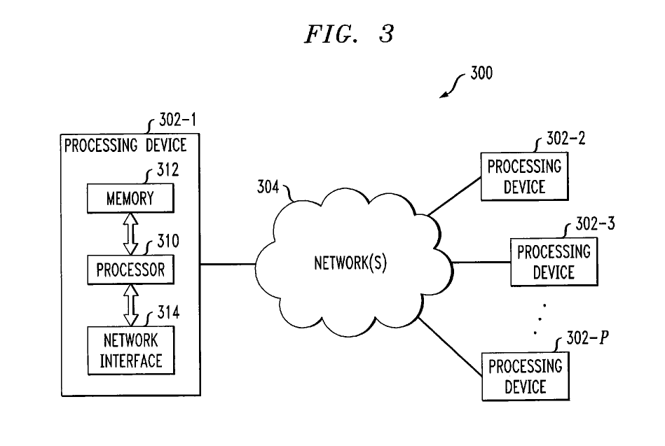

FIG. 3 illustrates a processing platform on which a communication network environment (e.g., 100 in FIG. 1) is implemented according to one or more embodiments of the invention. The processing platform 300 in this embodiment comprises a plurality of processing devices denoted 302-1, 302-2, 302-3, . . . 302-P, which communicate with one another over a network 304. One or more of the elements of data center 105 (load balancer 110, backend servers 112-1 through 112-n) and client(s) 102 may therefore each run on one or more computers or other processing platform elements, each of which may be viewed as an example of what is more generally referred to herein as a “processing device.” As illustrated in FIG. 3, such a device generally comprises at least one processor and an associated memory, and implements one or more functional modules for instantiating and/or controlling features of systems and methodologies described herein. Multiple elements or modules may be implemented by a single processing device in a given embodiment.

The processing device 302-1 in the processing platform 300 comprises a processor 310 coupled to a memory 312. The processor 310 may comprise a microprocessor, a microcontroller, an application-specific integrated circuit (ASIC), a field programmable gate array (FPGA) or other type of processing circuitry, as well as portions or combinations of such circuitry elements. Components of a system as disclosed herein can be implemented at least in part in the form of one or more software programs stored in memory and executed by a processor of a processing device such as processor 310. Memory 312 (or other storage device) having such program code embodied therein is an example of what is more generally referred to herein as a processor-readable storage medium. Articles of manufacture comprising such processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 312 may comprise electronic memory such as random access memory (RAM), read-only memory (ROM) or other types of memory, in any combination. The one or more software programs when executed by a processing device such as the processing device 302-1 causes the device to perform functions associated with one or more of the components/steps of system/methodology 300. One skilled in the art would be readily able to implement such software given the teachings provided herein. Other examples of processor-readable storage media embodying embodiments of the invention may include, for example, optical or magnetic disks.

Also included in the processing device 302-1 is network interface circuitry 314, which is used to interface the processing device with the network 304 and other system components. Such circuitry may comprise conventional transceivers of a type well known in the art.

The other processing devices 302 of the processing platform 300 are assumed to be configured in a manner similar to that shown for processing device 302-1 in the figure.

The processing platform 300 shown in FIG. 3 may comprise additional known components such as batch processing systems, parallel processing systems, physical machines, virtual machines, virtual switches, storage volumes, logical units, etc. Again, the particular processing platform shown in FIG. 3 is presented by way of example only, and environment 100 of FIG. 1 may include additional or alternative processing platforms, as well as numerous distinct processing platforms in any combination.

Also, numerous other arrangements of servers, computers, storage devices or other components are possible. Such components can communicate with other elements of the system over any type of network, such as a wide area network (WAN), a local area network (LAN), a satellite network, a telephone or cable network, a storage network, a converged network or various portions or combinations of these and other types of networks.

Furthermore, it is to be appreciated that the processing platform 300 of FIG. 3 can comprise virtual machines (VMs) implemented using a hypervisor. A hypervisor is an example of what is more generally referred to herein as “virtualization infrastructure.” The hypervisor runs on physical infrastructure. Processing platform 300 may also include multiple hypervisors, each running on its own physical infrastructure. As is known, VMs are logical processing elements that may be instantiated on one or more physical processing elements (e.g., servers, computers, processing devices). That is, a VM generally refers to a software implementation of a machine (i.e., a computer) that executes programs like a physical machine. Thus, different VMs can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other. In one embodiment, load balancer ecLB is implemented as a VM. Other elements in FIGS. 1 and 2 may be implemented as VMs in one or more embodiments of the invention.

Although certain illustrative embodiments are described herein in the context of communication networks utilizing particular communication protocols, other types of networks can be used in other embodiments. As noted above, the term “network” as used herein is therefore intended to be broadly construed. Further, it should be emphasized that the embodiments described above are for purposes of illustration only, and should not be interpreted as limiting in any way. Other embodiments may use different types of network, device and module configurations, and alternative communication protocols, process steps and operations for implementing load balancing functionality. The particular manner in which the user devices (e.g., clients) and network nodes (e.g., load balancers and backend servers) communicate can be varied in other embodiments. Also, it should be understood that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

What is claimed is:

1. A method, comprising:
selecting, at a load balancer, a processing device from a set of processing devices in a communication network to serve a request received by the load balancer from a client device;
forwarding the request from the load balancer to the selected processing device such that the selected processing device can provide at least one response to the client device without the response passing through the load balancer, wherein the response comprises a value inserted therein that is unique to the selected processing device;
receiving an acknowledgement at the load balancer from the client device, wherein the acknowledgement comprises the unique value associated with the selected processing device; and
forwarding the acknowledgement with the unique value from the load balancer to the selected processing device such that the selected processing device can delete state information associated with the request.

2. The method of claim 1, wherein the selection of the processing device is performed at least based on content associated with the request.

3. The method of claim 1, wherein the unique value associated with the selected processing device comprises a timestamp inserted by the selected processing device.

4. The method of claim 1, further comprising the load balancer sending an acknowledgement to the client device upon receipt of the request.

5. The method of claim 4, wherein the acknowledgement sent to the client comprises a timestamp inserted by the load balancer representing the current time.

6. The method of claim 5, wherein the acknowledgement sent to the client comprises a prefix value inserted by the load balancer.

7. The method of claim 6, wherein the acknowledgement sent to the client comprises a window size, inserted by the load balancer, specifying a limit as to the amount of data the client can send.

8. The method of claim 4, further comprising the load balancer dropping a subsequent response sent from the client device that does not include data.

9. The method of claim 1, further comprising the load balancer receiving a value from the selected processing device signaling the load balancer to re-perform selection of a processing device from the set of processing devices upon receipt of a subsequent request from the client device.

10. The method of claim 1, wherein the load balancer is configured to communicate with the client device and the set of processing devices via a Transmission Control Protocol (TCP).

11. The method of claim 10, wherein the request received by the load balancer from the client device comprises a SYN request.

12. The method of claim 1, wherein the load balancer is implemented as a virtual machine.

13. The method of claim 1, wherein one or more of the set of processing devices is a backend server associated with a data center.

14. An article of manufacture comprising a processor-readable storage medium having embodied therein executable program code that when executed by a processor of the load balancer causes the load balancer to perform the method of claim 1.

15. An apparatus, comprising:
a memory; and
a processor operatively coupled to the memory to form a load balancer configured to:
select a processing device from a set of processing devices in a communication network to serve a request received by the load balancer from a client device;
forward the request to the selected processing device such that the selected processing device can provide at least one response to the client device without the response passing through the load balancer, wherein the response comprises a value inserted therein that is unique to the selected processing device;
receive an acknowledgement from the client device, wherein the acknowledgement comprises the unique value associated with the selected processing device; and
forward the acknowledgement with the unique value to the selected processing device such that the selected processing device can delete state information associated with the request.

16. The apparatus of claim 15, wherein the selection of the processing device is performed at least based on content associated with the request.

17. The apparatus of claim 15, wherein the unique value associated with the selected processing device comprises a timestamp inserted by the selected processing device.

18. The apparatus of claim 15, wherein the load balancer is further configured to send an acknowledgement to the client device upon receipt of the request.

19. The apparatus of claim 18, wherein the acknowledgement sent to the client comprises a timestamp inserted by the load balancer representing the current time.

20. The apparatus of claim 19, wherein the acknowledgement sent to the client comprises a prefix value inserted by the load balancer.

21. The apparatus of claim 20, wherein the acknowledgement sent to the client comprises a window size specifying a limit as to the amount of data the client can send.

22. The apparatus of claim 18, wherein the load balancer is further configured to drop a subsequent response sent from the client device that does not include data.

23. The apparatus of claim 15, wherein the load balancer is further configured to receive a value from the selected processing device signaling the load balancer to re-perform selection of a processing device from the set of processing devices upon receipt of a subsequent request from the client device.

24. A method, comprising:
sending a request from a client device to a communication network, wherein the communication network comprises a load balancer for receiving the request and selecting a processing device from a set of processing devices to serve the request;
receiving at least one response to the request from the selected processing device without the response passing through the load balancer, wherein the response comprises a value inserted therein that is unique to the selected processing device; and
sending an acknowledgement to the load balancer, wherein the acknowledgement comprises the unique value associated with the selected processing device such that the load balancer can forward the acknowledgement with the unique value to the selected processing device such that the selected processing device can delete state information associated with the request.

25. A method, comprising:
receiving a request from a load balancer at a processing device selected from a set of processing devices of a communication network by the load balancer;
sending at least one response from the selected processing device to the client device without the response passing through the load balancer, wherein the response comprises a value inserted therein that is unique to the selected processing device;
receiving, at the selected processing device, an acknowledgement from the load balancer, sent to the load balancer by the client device, wherein the acknowledgement comprises the unique value associated with the selected processing device; and
deleting, at the selected processing device, state information associated with the request.
